(19) United States
(12) Patent Application Publication
(10) Pub. No.: US 2012/0232216 A1
(43) Pub. Date: Sep. 13, 2012

(54) FILLER BLENDING FOR RUBBER FORMULATIONS

(76) Inventor: Xiaofeng Shaw Yang, Simpsonville, SC (US)

(21) Appl. No.: 13/510,632

(22) PCT Filed: Dec. 3, 2009
(86) PCT No.: PCT/US09/66553

§ 371 Date: May 18, 2012

(51) Int. Cl. C08K 3/04; C08L 21/00

(52) U.S. Cl. 524/571; 106/472

(57) ABSTRACT

Using a target loading value and target intrinsic properties desired for a rubber formulation, two or more fillers are combined to create a blend having the desired intrinsic properties—i. e. a blend can be created emulating the desired intrinsic properties of a single filler system. In another exemplary aspect, knowing the individual loadings of fillers along with the target values desired for the loading of the blend and its intrinsic properties, individual intrinsic properties for at least one unknown filler that will be used to create the blend can be calculated. The unknown filler can then be identified by comparing the calculated intrinsic properties with the intrinsic properties of known fillers. The method allows e.g.) a manufacturer to blend a variety of suitable fillers while maintaining a more limited inventory of fillers than would otherwise be required for multiple rubber formulations.

### FIELD OF THE INVENTION

The present invention relates to a method of filler blending for rubber formulations. More particularly, the present invention provides a method of combining two or more fillers (e.g., carbon blacks) so as to provide a blend having the desired intrinsic properties for creating the rubber formulation.

### BACKGROUND OF THE INVENTION

In many rubber formulations, fillers having specific intrinsic properties are used to modify the performance of polymers or elastomers, such as increasing their modulus, improving abrasion, modifying electrical conductivity, and other desired modifications. Commercially available reinforcing fillers for rubber formulations may include carbon black, silica, alumina silicate, titanium oxide, zeolite, clays, and other components. These fillers are required to have certain intrinsic properties such as e.g., surface area, porosity, surface activity, and structure that are critical to creating rubber formulations having the desired visco-elastic behavior for use in e.g., tires.

Among available fillers, carbon black is the most widely used filler in rubber goods. Carbon black is produced from the partial combustion or thermal decomposition of organic substances. Essentially elemental carbon, it has many applications including inks, paints, plastics, and others. The predominant use of carbon black is in combination with elastomers for use in manufacturing tires. In such case, the carbon black serves as filler that favorably modifies the mechanical and conductive properties of the rubber to provide formulations more suitable for tire usage while also providing a raw material historically less expensive than rubber. For purposes of this description, “carbon black”, “reinforcing carbon black”, “filler”, and “reinforcing filler” are used interchangeably herein with the understanding that these references are to particulate fillers that will provide the intrinsic properties targeted for a rubber formulation

The reinforcing performance of a filler in a rubber formulation is very dependent on the intrinsic properties of the particular filler that is used. For example, carbon black fillers can differ in particle size, particle size distribution, surface activity, surface area, structure, pH value, and other properties that define the physiochemical properties of carbon black. ASTM D 1765-01 provides for the Standard Classification of Carbon Blacks Used in Rubber Products, and a substantial number of different carbon blacks are available based upon this classification system. In addition, new fillers such as e.g., new carbon blacks of unique intrinsic properties are still being researched and developed to meet the increased and changing needs of reinforced rubber goods. As a consequence, a broad range of rubber performance results are available and anticipated from the different rubber formulations that can be created when using one of the various fillers to reinforce elastomers.

In the case of carbon black fillers, because of the density of carbon black and the large quantities that are used in the rubber tire industry for production, carbon blacks are typically stored in bulk and require extensive material handling systems for transport and processing. As a result, while it may be desirable to have a large selection of different carbon blacks available so that multiple, performance-tailored rubber formulations can be provided, maintaining an expansive inventory is undesirable due to the costs of the material and expenses associates with the storage and handling requirements of such large quantities. Conversely, while maintaining only a single carbon black filler would provide costs savings as compared to a larger inventory, the narrow range of performance options resulting from the delimiting of rubber formulations would be unacceptable for a large scale tire manufacturer.

Accordingly, a solution is needed that allows for creating multiple rubber formulations needed for various rubber performances using only a limited number of fillers including e.g., carbon black fillers. More particularly, a solution is needed that provides for the creation of a wide range of rubber formulations (i.e. mixtures of rubber and fillers) without the necessity of inventorying vast numbers of fillers or developing new fillers of unique properties for each of numerous formulations. A method that can blend a few fillers so as to create a single blend having the intrinsic properties desired for a particular rubber formulation and, therefore, rubber performance would be very useful. Such a method would allow a manufacturer to forgo creation and/or storage of unique fillers for each anticipated rubber formulation. These and other advantages of the present invention will be apparent from the description that follows.

### SUMMARY OF THE INVENTION

Aspects and advantages of the invention will be set forth in part in the following description, or may be obvious from the description, or may be learned through practice of the invention.

The present invention provides a method of blending two or more fillers (including fillers that may contain carbon black) so as to provide a single filler having the desired intrinsic properties for creating a particular rubber formulation. For example, in one exemplary aspect, the present invention provides a method for combining fillers to create a blend for use in a rubber formulation. The method can include selecting n intrinsic properties for the blend; providing n number of mathematical equations setting forth relationships between the loading value L for the rubber formulation, n intrinsic property values Xᵢ desired for the blend, the corresponding intrinsic property values xᵢⱼ of each of the n fillers, and the loading value Lⱼ of each of the n fillers; identifying values for all but n of the values in the group that includes L, Xᵢ, xᵢⱼ, and n so as to result in n unknown values from the group that includes L, Xᵢ, Lⱼ, xᵢⱼ, and n; solving the n mathematical equations for the n unknown values; and creating a blend from the n fillers using the values from the identifying and solving steps Various combinations of unknowns maybe solved for using this exemplary aspect of the invention. For example, the unknown values may include n loading values Lⱼ for the fillers, n intrinsic property values Xᵢ desired for the blend, n intrinsic property values xᵢⱼ for one of the fillers, and n number of any combination of the loading value L, loading values Lⱼ, intrinsic property values Xᵢ, or intrinsic property values xᵢⱼ.

By way of further example, the present invention provides a method for creating a blend of fillers for use as in a rubber formulation. This exemplary method can include the steps of selecting a target loading value L desired for the rubber formulation; deciding upon n target intrinsic properties that are desired for the blend, where n is an integer greater than one; choosing a target intrinsic property value Xᵢ for each of the n target intrinsic properties; picking n fillers suitable for use in creating the blend; providing, for each of the n target intrinsic properties, a mathematical relationship fᵢ between the target loading value L, the target intrinsic property value Xᵢ, the corresponding intrinsic property value xᵢⱼ, and the loading Lⱼ of each of the n fillers from the picking step; and calculating the loading Lⱼ for each of the n fillers from the picking step.

As needed, one of the n target intrinsic properties Xᵢ desired for the blend can be the structure of filler in the blend, the surface area of filler in the blend, or both. The mathematical relationship fᵢ for each of the n target intrinsic properties can be a first order equation that includes the individual loadings Lⱼ and intrinsic property values xᵢⱼ for each of the n fillers from the picking step. These n mathematical relationships fᵢ may be linearly independent from one another or dependent on one another. Alternatively, rather than linear, the mathematical relationships may be polynomials, power, exponential, or other.

This exemplary method can further include the step of blending the n fillers from the picking step according to the loadings Lⱼ provided by the calculating step so as to create the filler. Additionally, the method can further include the step of manufacturing a tire using the filter from the blending step.

In another exemplary aspect of the present invention, a method for creating a blend of fillers for use in a rubber formulation is provided that includes the steps of selecting the target loading value L for the rubber formulation; deciding upon n target intrinsic properties that are desired for the blend, where n is an integer greater than one; choosing a target intrinsic property value Xᵢ for each of the n target intrinsic properties; picking a loading value Lⱼ for each of n fillers that will be used in creating the blend; providing, for each of the n target intrinsic properties, a mathematical relationship fᵢ between the target loading value L, the target intrinsic property value Xᵢ, the corresponding intrinsic property value xᵢⱼ, and the loading Lⱼ of each of the n fillers from the picking step; calculating the corresponding intrinsic property values xᵢⱼ for the unidentified filler from said choosing step; and determining the identity of the unidentified filler from said choosing step by matching the intrinsic property values xᵢⱼ from said calculating stop with a filler having substantially the same intrinsic property values xᵢⱼ as provided by said calculating step.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWING

A full and enabling disclosure of the present invention, including the best mode thereof, directed to one of ordinary skill in the art, is set forth in the specification, which makes reference to the appended figures, in which:

FIG. 1 provides a plot of structure vs. surface area for linearly dependent equations as further described below.

FIG. 2 provides a plot of structure vs. surface area for linearly independent equations as further described below.

FIG. 3 provides a plot of CDBP versus CTAB as further described below.

### DETAILED DESCRIPTION OF THE INVENTION

The present invention provides a method for creating a blend of two or more fillers (including carbon black fillers) having the intrinsic properties desired for a particular rubber formulation—i.e., the resulting blend emulates a single filler having the intrinsic properties required to create a specified rubber performance. By way of example, the present invention can be used to combine fillers having different intrinsic properties to create a new blend having the intrinsic properties needed for a particular rubber formulation. Accordingly, the preset invention provides advantages in e.g., allowing a tire manufacturer to inventory fewer fillers while having the ability to provide an array of blends (created from the inventoried fillers) having the intrinsic properties required for a variety of rubber formulations.

For purposes of describing the invention, reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used with another embodiment to yield a still further embodiment. Thus, it is intended that the present invention covers such modifications and variations as come within the scope of the appended claims and their equivalents.

For use in the present description, the following terms are defined as indicated:

“parts per hundred rubber” or “phr” means the amount by weight parts of an ingredient per 100 weight parts of elastomer in a rubber formulation. For example, 5.0 phr of carbon black means 50 pounds of carbon black per 100 pounds of rubber.

“Blend” as used herein means a combination of different fillers that will be used in creating a rubber formulation. As such, this blend will emulate a single filler having the intrinsic properties desired for such rubber formulation.

L as used herein refers to the amount of filler (such as e.g., carbon black) in a rubber formulation. L can be phr but other units and bases to denote filler composition may be used as well. L will refer to the loading value for the rubber formulation as if a single filler were being used to provide the intrinsic properties desired.

Lⱼ as used herein refers to the individual loadings of fillers selected for creating a blend that will be used to emulate the single filler—as will be further described below. As will be discussed below, the invention does not require that the sum of the Lⱼ equal L.

“Intrinsic property” refers to any one of various physical and/or chemical properties of a filler or a blend of such fillers. While “structure” and “surface area” are typically the intrinsic properties of most interest for carbon black fillers in rubber formulations, the present invention is not limited thereto and includes other intrinsic properties such as e.g., particle size distribution, surface activity, pH value, and others that define the physical and/or chemical properties of carbon black.

Xᵢ denotes the intrinsic property value needed for a particular rubber formulation. As further described below, Xᵢ can also become the target intrinsic property value desired for a blend of fillers. Subscript i identifies which particular intrinsic property value is being referenced.

xᵢⱼ denotes the value for the corresponding intrinsic property of a filler j, and subscript j identifies which filler of a total number of n fillers has this particular intrinsic property value.

“Structure” is an intrinsic property of carbon black that is defined by ASTM D3053 as the quality of irregularity and deviation from sphericity of the shape of a carbon black aggregate,

“CDBP” is an oil absorption test that applies the techniques of ASTM D2414 to determine the structure of carbon black.

“Surface area” is an intrinsic property of carbon black that indicates the particle size of carbon black. Surface area can be measured using ASTM D3765, which is also referred to herein as the “CTAB” test.

“Rubber” refers to natural rubber and/or any elastomers suitable for use in any viseo-elastic applications such as tire construction. “Rubber” can also refer to a rubber formulation containing elastomers and other ingredients used in the formulation.

For creating a rubber formulation, conventionally a phr of a filler that has each of a certain number of desired intrinsic properties is selected for combing with rubber. Stated alternatively, a loading value L of a filler having n desired intrinsic property values Xᵢ is selected for combining with rubber. For example, a manufacturer might decide that a particular rubber formulation needs 50 phr of a single filler (e.g., a single, carbon black) and specify a certain CDBP value for structure, a certain CTAB value for surface area, and a certain value for surface activity such that the number of intrinsic properties that are specified is three, or n=3. More or less intrinsic properties could also be of interest such that n is a larger or smaller integer, and the present invention can be used with these other n values provided n is a positive integer greater than one.

In its inventory, a manufacturer may have a single filler meeting the desired intrinsic properties. If, however, such a filler is unavailable in inventory, the present invention provides a method that can use other suitable fillers that are available in the inventory to create a blend that has (or reasonably approximates) the desired intrinsic properties—i.e. to emulate a single filler having the desired intrinsic property values. In such case, the loading value of L of the unavailable, single filler becomes the target loading value L of the blend that will be created from the fillers that are available. Similarly, the specified n intrinsic property values Xᵢ of the unavailable filler become the a target intrinsic property values Xᵢ desired for the blend.

To create this blend, a total of n fillers are picked from the existing inventory of fillers. More specifically, a total of n fillers—for which the corresponding intrinsic property values xᵢⱼ are known—are picked from the existing inventory for use in creating the blend. Returning to the example above, n=3 and the intrinsic property values Xᵢ of structure (S), surface area (A), and surface activity (M) that were chosen for the unavailable filler become the target intrinsic properties of S, A, and M. The manufacturer picks three fillers from inventory for which the corresponding intrinsic property values xᵢⱼ of structure (s), surface area (aᵢ), and surface activity (mᵢ) are known for each,

Next, for each of the n intrinsic properties that have been targeted, a mathematical relationship fᵢ is provided between the target loading value L of the unavailable filler, the target intrinsic property value Xᵢ of the unavailable filler, the corresponding intrinsic properₜy value xᵢⱼ, and the loading Lⱼ of each of the n available fillers that were picked. These mathematical relationships or equations fᵢ could be provided by e.g., theoretical modeling of physical and/or chemical properties, curve fitting of empirical data, or any reasonable expression of the physiochemical “dependency” of the intrinsic properties of the unavailable and available fillers that were picked. Thus, the mathematical relationship fᵢ could be linear, polynomial, power, exponential, or otherwise, These n mathematical relationships fᵢ can be represented as follows:

$$n mathematical relationships \\ \{ \begin{matrix}{X}_{1} ( L ) = {f}_{1} ( {x}_{11} , {x}_{12} , … , {x}_{1 j} , … , {x}_{1 n} , {L}_{1} , {L}_{2} , … , {L}_{j} , … , {L}_{n} ) \\ {X}_{2} ( L ) = {f}_{2} ( {x}_{21} , {x}_{22} , … , {x}_{2 j} , … , {x}_{2 n} , {L}_{1} , {L}_{2} , … , {L}_{j} , … , {L}_{n} ) \\ … \\ {X}_{i} ( L ) = {f}_{i} ( {x}_{i 1} , {x}_{i 2} , … , {x}_{ij} , … , {x}_{in} , {L}_{1} , {L}_{2} , … , {L}_{j} , … , {L}_{n} ) \\ … \\ {X}_{n} ( L ) = {f}_{n} ( {x}_{n 1} , {x}_{n 2} , … , {x}_{nj} , … , {x}_{n n} , {L}_{1} , {L}_{2} , … , {L}_{j} , … , {L}_{n} )\end{matrix} \qquad ( 1 )$$

where:
Xᵢ and xᵢⱼ are the i^{th} intrinsic properties of the target blend and the available, individual fillers respectively.

Mathematically, if these n equations are linearly independent, n unknowns of any combination can be solved for either analytically or numerically. For example, any combination of n unknowns such as (L₁, L₂, . . . Lₙ), (x₂₁, x₂₂, . . . , x₂ₙ), (X₁, X₂, . . . , Xₙ), (L₁, X₁₃, X₂, can be solved.

Returning to the previous example of n=3 where the manufacturer has specified the desired loading L and three intrinsic properties S, A, and M for the unavailable single filler (which will now be emulated by a blend), using the equations set forth above the individual loadings Lⱼ can now be calculated for each of the three fillers that were picked. More particularly, assuming that the corresponding intrinsic properties xᵢⱼ and loadings Lⱼ of the three fillers are related to the target intrinsic property value Xᵢ and the target loading value Lⱼ of the blend by first order mathematical expressions, then the following equations can be provided:

L₁a₁+L₂a₂+L₃a₃=LA

L₁s₁+L₂s₂+L₃s₃=LS

L₁m₁+L₂m₂+L₃m₃=LM (2)

where:
the corresponding intrinsic properties xᵢⱼ of filler j are now represented as aᵢ for surface area, sᵢ for structure, and mᵢ for surface energy;
and the target intrinsic properties for the blend (i.e., the unavailable filler) are represented as A for surface area, S for structure, and M for surface energy.

At this point, every parameter is known except for the individual loadings Lⱼ. Using matrix expressions, the equations can be readily solved for the individual loadings L₁, L2, and L₃:

$$( \begin{matrix}{a}_{1} & {a}_{2} & {a}_{3} \\ {s}_{1} & {s}_{2} & {s}_{3} \\ {m}_{1} & {m}_{2} & {m}_{3}\end{matrix} ) ( \begin{matrix}{L}_{1} \\ {L}_{2} \\ {L}_{3}\end{matrix} ) = ( \begin{matrix}LA \\ LS \\ LM\end{matrix} ) = L ( \begin{matrix}A \\ S \\ M\end{matrix} ) \qquad ( 3 )$$

Accordingly, if the following is true

$$\begin{matrix}\vert \begin{matrix}{a}_{1} & {a}_{2} & {a}_{3} \\ {s}_{1} & {s}_{2} & {s}_{3} \\ {m}_{1} & {m}_{2} & {m}_{3}\end{matrix} \vert \neq 0 \\ and & ( 4 ) \\ ( ASM ) = \vert \begin{matrix}{a}_{1} & {a}_{2} & {a}_{3} \\ {s}_{1} & {s}_{2} & {s}_{3} \\ {m}_{1} & {m}_{2} & {m}_{3}\end{matrix} \vert , {( ASM )}_{1} = \vert \begin{matrix}A & {a}_{2} & {a}_{3} \\ S & {s}_{2} & {s}_{3} \\ M & {m}_{2} & {m}_{3}\end{matrix} \vert , \\ {( ASM )}_{2} = \vert \begin{matrix}{a}_{1} & A & {a}_{3} \\ {s}_{1} & S & {s}_{3} \\ {m}_{1} & M & {m}_{3}\end{matrix} \vert , {( ASM )}_{3} = \vert \begin{matrix}{a}_{1} & {a}_{2} & A \\ {s}_{1} & {s}_{2} & S \\ {m}_{1} & {m}_{2} & M\end{matrix} \vert & ( 5 )\end{matrix}$$

then the solutions are as follows:

$${L}_{1} = L \frac{{( ASM )}_{1}}{( ASM )} = L \frac{{m}_{2} {Sa}_{3} + {Ms}_{3} {a}_{2} + {m}_{3} {s}_{2} A - ( {m}_{2} {s}_{3} A + {m}_{3} {Sa}_{2} + {Ms}_{2} {a}_{3} )}{{m}_{2} {s}_{1} {a}_{3} + {m}_{1} {s}_{3} {a}_{2} + {m}_{3} {s}_{2} {a}_{1} - ( {m}_{2} {s}_{3} {a}_{1} + {m}_{3} {s}_{1} {a}_{2} + {m}_{1} {s}_{2} {a}_{3} )} \\ {L}_{2} = L \frac{{( ASM )}_{2}}{( ASM )} = L \frac{{Ms}_{1} {a}_{3} + {m}_{1} {s}_{3} A + {m}_{3} {Sa}_{1} - ( {Ms}_{3} {a}_{1} + {m}_{3} {s}_{1} A + {m}_{1} {Sa}_{3} )}{{m}_{2} {s}_{1} {a}_{3} + {m}_{1} {s}_{3} {a}_{2} + {m}_{3} {s}_{2} {a}_{1} - ( {m}_{2} {s}_{3} {a}_{1} + {m}_{3} {s}_{1} {a}_{2} + {m}_{1} {s}_{2} {a}_{3} )} \\ {L}_{3} = L \frac{{( ASM )}_{3}}{( ASM )} = L \frac{{m}_{2} {s}_{1} A + {m}_{1} {Sa}_{2} + {Ms}_{2} {a}_{1} - ( {m}_{2} {Sa}_{1} + {Ms}_{1} {a}_{2} + {m}_{1} {s}_{2} A )}{{m}_{2} {s}_{1} {a}_{3} + {m}_{1} {s}_{3} {a}_{2} + {m}_{3} {s}_{2} {a}_{1} - ( {m}_{2} {s}_{3} {a}_{1} + {m}_{3} {s}_{1} {a}_{2} + {m}_{1} {s}_{2} {a}_{3} )} \qquad ( 6 )$$

It should be noted that the actual loading that results from creating a blend of n fillers using the calculated loadings Lⱼ for each of n fillers will likely be different than the target loading value L of the blend (i.e. the unavailable filler) as will be further explained below.

A similar process could be followed for determining the fillers having unknown intrinsic properties that will be used to create the blend (i.e. the unavailable filler) based on a predetermined selection of individual loadings for such fillers. More particularly, assume as before that a value of L is again selected as the target loading value of the blend (i.e. the unavailable filler), that n target intrinsic properties are decided upon, and that n target intrinsic property values Xᵢ are chosen for the blend. Now, instead of choosing the intrinsic properties of n fillers from inventory as in the example above, a loading Lⱼ is picked for each of the n fillers (the identity of which is yet unknown at this point) that will be used in creating the blend.

As before, a mathematical relationship fᵢ is provided between the target loading value L, the target intrinsic property value Xᵢ, the corresponding intrinsic property value xᵢⱼ, and the loading Lⱼ of each of the n fillers that were picked. In addition, the intrinsic property values xᵢⱼ for n−1 of the individual fillers that will be used in creating the blend is also provided. For example, this may be selected from the known intrinsic properties of n−1 fillers that are available in inventory. The result will be n equations with n unknowns, namely the xᵢⱼ values for one yet unidentified filler,

Assuming again that the corresponding intrinsic properties xᵢⱼ and loadings Lⱼ of the known and unknown fillers are related to the target intrinsic property value Xᵢ and the target loading value Lⱼ of the blend by first order mathematical expressions, then the equations at (2) above can be solved in a manner similar to that previously described so that the intrinsic property values xᵢⱼ for the unknown filler can be calculated as shown below:

$${a}_{3} = \frac{LA - ( {La}_{1} + {L}_{2} {a}_{2} )}{{L}_{3}} \\ {s}_{3} = \frac{LS - ( {L}_{1} {s}_{1} + {L}_{2} {s}_{2} )}{{L}_{3}} \\ {m}_{3} = \frac{LM - ( {L}_{1} {m}_{1} + {L}_{2} {m}_{2} )}{{L}_{3}} \qquad ( 7 )$$

Once the intrinsic property values of the unknown filler has been calculated, the identity of a filler having substantially the same intrinsic property values xᵢ as the calculated values can be determined. For example, the manufacturer can search its inventory for a filler having the same or substantially similar intrinsic property values.

Therefore, the present invention provides a method for creating a blend having the target intrinsic property values by blending fillers that may have different intrinsic property values. As set forth above, for a selected target loading L and known target intrinsic properties Xᵢ, the manufacturer can select fillers from its inventory and solve for the loadings Lⱼ of each filler that will provide the desired intrinsic properties Xᵢ for the blend. Alternatively, for a known target loading L and known target intrinsic properties Xᵢ, the manufacture can select n−1 fillers from inventory and specify n loadings Lⱼ for the n−1 selected fillers and one unknown filler (where n will represent the number of intrinsic properties the manufacturer wishes to specify for the blend). The manufacturer can then calculate the intrinsic properties xᵢⱼ for the unknown filler that will be combined with other selected fillers to make the blend. The manufacturer can then match or compare the calculated values of xᵢⱼ for the unknown filler with the intrinsic properties of the fillers in inventory so as to identify a filler that will be combined with the already identified fillers for Use in creating the blend.

In yet another alternative of the invention, using the teachings set forth herein, it will be understood that the manufacturer could vary the target loading value L and use existing fillers in inventory to provide intrinsic properties Xᵢ of the blend as needed. For example, the manufacturer could specify n intrinsic properties values Xᵢ for the blend. To create the blend, the manufacturer would then select n fillers from existing inventory with known intrinsic properties xᵢⱼ and specify their individual loadings Lⱼ. The resulting intrinsic properties Xᵢ of the blend will then vary with the target loading L of the blend. Assuming again that the manufacturer wishes to focus on the intrinsic properties of surface area A, structure S, and surface energy M, the equations above can be solved to provide the following:

$$A = \frac{{L}_{1} {a}_{1} + {L}_{2} {a}_{2} + {L}_{3} {a}_{3}}{L} \\ {}^{‵} S = \frac{{L}_{1} {s}_{1} + {L}_{2} {s}_{2} + {L}_{3} {s}_{3}}{L} \\ M = \frac{{L}_{1} {m}_{1} + {L}_{2} {m}_{2} + {L}_{3} {m}_{3}}{L} \qquad ( 8 )$$

Accordingly, using at least three fillers from existing inventory, the manufacturer could mix the fillers and vary the loading L to achieve the desired intrinsic properties. Furthermore, the manufacturer could mix existing fillers with elastomers and other ingredients to create a new rubber formulation with new performances to meet new or increased needs.

To provide further description of the invention, additional examples will be provided using structure S and surface area A as the intrinsic properties of interest for a particular rubber formulation. These two intrinsic properties will be selected for further example as it is presently believed that the same are the most dominant. factors in determining the salient properties of most rubber formulations such as those used in tire manufacturing. More variables representing other intrinsic properties of the filler would provide a more precise representation of blending but make the description more complicated (as shown above) and may be unnecessary nonetheless.

Therefore, as two variables will be unknown from structure sⱼ, surface area aⱼ, or the individual loadings Lⱼ of two fillers, two different fillers will be used for creating the blend. If it is correct to assume that there is no “interaction” between these two fillers or that any “interaction.” will not impact the effective surface area aⱼ and structure sⱼ of either filler and thus the formulated rubber properties, then linear or first order equations may again be provided. With these assumptions, the mathematical relationships become:

L₁a₁+L₂a₂=LA

L₁s₁+L₂s₂=LS

These equations can be rearranged as;

$${L}_{1} \frac{{a}_{1}}{A} + {L}_{2} \frac{{a}_{2}}{A} = L \\ {L}_{1} \frac{{s}_{1}}{S} + {L}_{2} \frac{{s}_{2}}{S} = L \qquad ( 10 )$$

where:

as before, A, S, and L are the surface area, structure, and loading of the blend, and aⱼ, sⱼ, and Lⱼ are the surface area, structure, and loading of the two carbon blacks (n=2) that will be used to create the blend.

As previously described (and depending upon the linearity of these two equations), the solutions of any two unknowns can be obtained from solving these two equations.

As an example, assuming a manufacturer would like to know the non-zero loadings L₁ and L₂ of carbon blacks “1” and “2”, such can be calculated from the equations above using the known surface areas a₁ and a₂ and structures s₁ and s₂ of carbon blacks “1” and “2.” The target intrinsic property values of L, S, and A of the blend are also known because these are determined in advance for a given rubber formulation—i.e., these are determined as if a single filler was available for creating the rubber formulation desired. Depending upon the linearity of the two mathematical equations, there will be two cases in Solving the above equations.

In the first case, if the two equations are linearly dependent, then there will be infinite solutions for L₁ and L₂—i.e., there will always be a value for L₁ for a given value of or vice versa provided that both L₁ and L₂ must be positive. This can be expressed by the following equation

$${L}_{1} = L \frac{A}{{a}_{1}} - {L}_{2} \frac{{a}_{2}}{{a}_{1}} = L \frac{S}{{s}_{1}} - {L}_{2} \frac{{s}_{2}}{{s}_{1}} \qquad ( 11 )$$

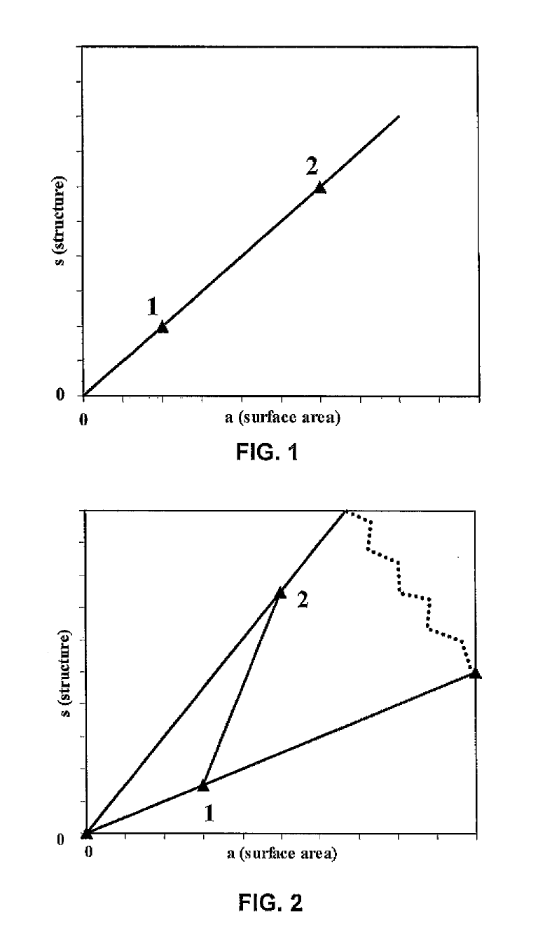

Physically, as depicted in FIG. 1, these equations mean that on a plot of structure vs. surface area, if any two of either the blend or the two fillers used to create the blend are on a straight line through the origin, then the other one must be on the same straight line in order for the above equation (11) to be true.

In the second case, if the above two equations are linearly independent, or

$$if {a}_{1} {s}_{2} \neq {a}_{2} {s}_{1} then \{ \begin{matrix}{L}_{1} = - \frac{{a}_{2} S - {As}_{2}}{{a}_{1} {s}_{2} - {a}_{2} {s}_{1}} L \\ {L}_{2} = \frac{{a}_{1} S - {As}_{1}}{{a}_{1} {s}_{2} - {a}_{2} {s}_{1}} L\end{matrix} \} . \qquad ( 12 )$$

In such case, to ensure positive values for L₁ and L₂, the ranges of the intrinsic properties of surface area A and structure S are as follows:

$$if \frac{{s}_{2}}{{a}_{2}} > \frac{{s}_{1}}{{a}_{1}} then \frac{{s}_{2}}{{a}_{2}} > \frac{S}{A} > \frac{{s}_{1}}{{a}_{1}} \\ if \frac{{s}_{2}}{{a}_{2}} < \frac{{s}_{1}}{{a}_{1}} then \frac{{s}_{2}}{{a}_{2}} < \frac{S}{A} < \frac{{s}_{1}}{{a}_{1}} \qquad ( 13 )$$

FIG. 2 shows a plot of structure S versus surface area A for the case where these properties for fillers 1 and 2 are linearly independent. Note that these two fillers are not located on any single straight line passing through the origin. The cone that projects from the origin indicates the range of fillers that could solve the linear equations set forth at (9) or (10) above. More specifically, the inequalities set forth above at (13) mean if the straight line connecting a plot of a₁, s₁ and a₂, s₂ does not pass through the origin, then the slope of the line for the blend—i.e. the solutions of structure S and surface area A that will solve the equations at (9) or (10) above—will fall in between s₁/a₁ and s₂/a₂ or in the enclosed cone area. In addition, there will be one and only one solution for a given loading pair L₁, L₂. Notice that the ratio of sᵢ/a₁, not the absolute values of sᵢ and/or aᵢ, governs the positive Lⱼ values, while the absolute values of sᵢ and/or aᵢ will determine the exact values of L₁ and L₂.

As referenced earlier, it should be noted that regardless of whether the equations at (9) or (10) above are linearly dependent or independent, in most cases it will be mathematically impossible to have combined loadings for the carbon blacks (L₁+L₂) that equal the target value loading L. Such a solution is unnecessary because the main objective for the rubber formulation is to provide a blend having the desired intrinsic property values. It is believed that previous efforts at blending carbon blacks between single and blended systems reported discrepancies because e.g., a constraint of L₁+L₂=L was unnecessarily imposed.

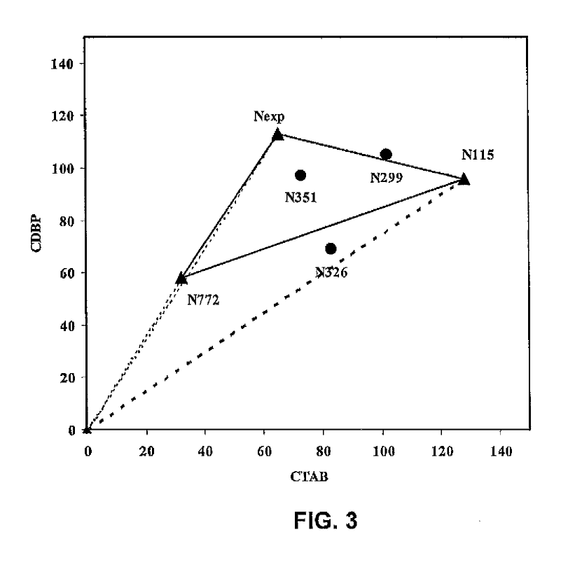

Examples of blends will now be provided to further describe the present invention, In these examples, for the carbon blacks that are used, it will be assumed that their intrinsic properties and loadings can be represented by linear relationships. It will also be assumed that CTAB and CDBP are accurate representations of surface areas and structure, respectively. Accordingly, Table 1 lists the CTAB and CDBP values of carbon blacks to be used in the examples while FIG. 3 provides a diagram of CTAB and CDBP.

TABLE 1

| | B1 | B2 | B3 | S1 | S2 | S3 |
|---|---|---|---|---|---|---|
| CB name | N115 | N772 | NEXP | N336 | N351 | N299 |
| CTAB (m²/g) | 128 | 32 | 65 | 83 | 73 | 102 |
| CDBP (ml/100 g) | 96 | 58 | 113 | 69 | 97 | 105 |

Note:
B = blend,
S = single,
NEXP is an experimental black.

Blends of N115+N772 and N115+NEXP were be used to predict the performance of N299, N326, and N351. As shown in FIG. 3, because the locations of N299, N326, N351 in this diagram fall outside of the origin-NEXP and origin-N772 lines, it is mathematically impossible to blend NEXP and N772 at any loadings to achieve equal CTAB and CDBP of N299, N326, or N351. For purposes of describing the invention here, these particular carbon blacks were selected because each has distinctive CTAB and CDBP values that illustrate an extreme application of the invention. More accurate predictability for the resulting blend can be made if carbon blacks that having closer CTAB and CDBP values are chosen.

More particularly, the three carbon black examples were chosen based on their location in FIG. 3:
N326: which is below both N772, N115 and NEXP, N115 lines
N351: which is above the N772, N115 line but below NEXP, N115 line
N299: which is very close to the NEXP, N115 line

Table 2 shows rubber compositions containing the phr loadings of each individual carbon black in the binary blends of N115+N772 and N115+NEXP that were obtained using linear blending equations as described above to predict the performance of N299, N326, and N351 at 50 phr loadings, respectively. It can be seen that most of the combined phr loadings in the blends are very different from those in the single black systems,

TABLE 2

| | Index | | | | | | | | | | | |
|---|---|---|---|---|---|---|---|---|---|---|---|---|
| | 56-1 | 1 | 56-2 | 67-2 | 67-5 | 67-8 | 67-3 | 67-7 | 67-10 | 67-4 | 67-6 | 67-9 |
| Sample | B1 | B2 | B3 | WS1 | B12-1 | B13-1 | WS2 | B12-2 | B13-2 | WS3 | B12-3 | B13-3 |
| NR | 100 | 100 | 100 | 100 | 100 | 100 | 100 | 100 | 100 | 100 | 100 | 100 |
| Paraffin | 1 | 1 | 1 | 1 | 1 | 1 | 1 | 1 | 1 | 1 | 1 | 1 |
| 6PPD | 2 | 2 | 2 | 2 | 2 | 2 | 2 | 2 | 2 | 2 | 2 | 2 |
| SAD | 2.5 | 2.5 | 2.5 | 2.5 | 2.5 | 2.5 | 2.5 | 2.5 | 2.5 | 2.5 | 2.5 | 2.5 |
| ZnO | 3 | 3 | 3 | 3 | 3 | 3 | 3 | 3 | 3 | 3 | 3 | 3 |
| S | 1.5 | 1.5 | 1.5 | 1.5 | 1.5 | 1.5 | 1.5 | 1.5 | 1.5 | 1.5 | 1.5 | 1.5 |
| Accelerator | 1.5 | 1.5 | 1.5 | 1.5 | 1.5 | 1.5 | 1.5 | 1.5 | 1.5 | 1.5 | 1.5 | 1.5 |
| N326 | | | | 50.00 | | | | | | | | |
| N351 | | | | | | | 50.00 | | | | | |
| N299 | | | | | | | | | | 50.00 | | |
| N115 | 50 | | | | 29.8 | 29.8 | | 12.1 | 11.8 | | 28.8 | 28.6 |
| N772 | | 50 | | | 10.2 | | | 63.5 | | | 42.9 | |
| NEXP | | | 50 | | | 5.3 | | | 32.9 | | | 22.2 |
| Total filler | 50 | 50 | 50 | 50 | 40 | 35 | 50 | 75.7 | 44.7 | 50 | 71.7 | 50.8 |
| phr | | | | | | | | | | | | |

Note:
W = witness,
B = blend, and
S = single filler

In the example of B13-3, since N299 on the plot of structure vs, surface area is quite close to the N115+NEXP straight line, the resulting combined blend loading, 50.8, is in fact close to the single N299 loading, 50. For further comparison, Table 3 provides the physical or mechanical properties of the above rubbers while Table 4 provides the percent difference between the blended and single carbon black systems, which was calculated as ((blend—carbon black)/carbon black)*100%.

TABLE 3

| | Index | | | | | | | | | | | |
|---|---|---|---|---|---|---|---|---|---|---|---|---|
| | 56-1 | 1 | 56-2 | 67-2 | 67-5 | 67-8 | 67-3 | 67-7 | 67-10 | 67-4 | 67-6 | 67-9 |
| Sample | B1 | B2 | B3 | WS1 | B12-1 | B13-1 | WS2 | B12-2 | B13-2 | WS3 | B12-3 | B13-3 |
| ML | 67.9 | 48.9 | 75.5 | 55.4 | 53.6 | 54.3 | 67.5 | 68.2 | 71.3 | 75.1 | 73.1 | 74.8 |
| S′max | 21.1 | 13.8 | 21.1 | 15.6 | 14.8 | 14.5 | 17.7 | 17.5 | 17.8 | 17.7 | 20.1 | 18.6 |
| MA10 | 5.15 | 3.55 | 4.98 | 4.55 | 4.03 | 3.90 | 5.40 | 5.92 | 5.02 | 5.77 | 6.30 | 6.08 |
| MA100 | 2.13 | 1.95 | 3.04 | 2.03 | 1.84 | 1.79 | 2.79 | 3.37 | 2.86 | 2.77 | 3.31 | 2.98 |
| MA300 | 2.56 | 2.28 | 3.85 | 2.47 | 2.20 | 2.12 | 3.54 | 3.90 | 3.48 | 3.34 | 3.88 | 3.53 |
| P60 | 21.4 | 10.9 | 13 | 17.2 | 15.2 | 14.7 | 16.8 | 16.6 | 14.4 | 20.5 | 19.9 | 20.6 |
| SCT (FR) | 31 | 29 | 29 | 31 | 32 | 33 | 34 | 25 | 30 | 30 | 26 | 30 |
| SCT (ER) | 531 | 575 | 407 | 562 | 617 | 644 | 468 | 410 | 485 | 498 | 426 | 485 |
| G*2% | 2.35 | 1.09 | 2.04 | 1.75 | 1.49 | 1.43 | 1.98 | 2.00 | 1.78 | 2.16 | 2.40 | 2.42 |
| G*50% | 1.31 | 0.93 | 1.5 | 1.05 | 1.02 | 0.99 | 1.28 | 1.37 | 1.26 | 1.26 | 1.43 | 1.42 |

Notes:
definitions for the test measurements in this table and herein after:
ML: uncured Mooney viscosity tested at 100° C.
S′max: maximum torque from curing rheometry test
MA10: modulus at 10% elongation @ 23° C. (MPa)
MA100: modulus at 100% elongation @ 23° C. (MPa)
MA300: modulus at 300% elongation @ 23° C. (MPa)
P60: Hysteresis Losses @ 60° C. (%)
SCT (FR): Elongation Break Stress (MPa)
SCT (ER): Elongation Break Strain (%)
G*2%: dynamic modulus at 2% strain
G*50%: dynamic modulus at 50% strain

TABLE 4

| | Index | | | | | |
|---|---|---|---|---|---|---|
| | 67-5/2 | 67-8/2 | 67-7/3 | 67-10/3 | 67-6/4 | 67-9/4 |
| ML | −3% | −2% | 1% | 6% | −3% | −1% |
| S′max | −5% | −7% | −2% | 0% | 14% | 5% |
| MA10 | −11% | −14% | 10% | −7% | 9% | 5% |
| MA100 | −9% | −12% | 21% | 3% | 20% | 8% |
| MA300 | −11% | −14% | 10% | −2% | 16% | 6% |
| P60 | −12% | −15% | −1% | −14% | −3% | 0% |
| SCT (FR) | 5% | 7% | −16% | 1% | −14% | 0% |
| SCT (ER) | 10% | 15% | −13% | 4% | −15% | −3% |
| G*2% (10 Hz) | −15% | −18% | 1% | −10% | 11% | 12% |
| G*50% | −3% | −6% | 7% | −1% | 14% | 13% |
| (10 Hz) | | | | | | |

Note:
The % was defined by values of (Blends-Single)/Single * 100% from Table 3.

As indicated by these Tables, the green rubber viscosity of the blends is quite close to that of the corresponding single carbon black system. Further, most of the cured properties such as e.g., static and dynamic rigidity, elongation, and hysteresis, are close to the properties of the corresponding single carbon black systems with a deviation of less than 20 percent. Accordingly, the assumption of linearity for these carbon blacks provides reasonable, accuracy for predicting the blends.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method for combining fillers to create a blend for use in a rubber formulation, comprising the steps of:
selecting n intrinsic properties for the blend;
providing n number of mathematical equations setting forth relationships between the loading value L for the rubber formulation, n intrinsic property values Xᵢ desired for the blend, the corresponding intrinsic property values xᵢⱼ of each of the n fillers, and the loading value Lⱼ of each of the n fillers;
identifying values for all but n of the values in the group that includes L, Xᵢ, xᵢⱼ, and n so as to result in n unknown values from the group that includes L, Xᵢ, Lⱼ, xᵢⱼ, and n;
solving the n mathematical equations for the n unknown values; and
creating a blend from the n fillers using the values from said identifying and solving steps.

2. A method for combining fillers to create a blend for use in a rubber formulation as in claim 1, wherein the n mathematical equations are first order equations.

3. A method for combining fillers to create a blend for use in a rubber formulation as in claim 1, wherein the intrinsic property values resulting from said selecting step comprise structure and surface area.

4. A method for combining fillers to create a blend for use in a rubber formulation as in claim 1, further comprising the step of creating a rubber formulation using the blend from said creating step.

5. A method for creating a blend of fillers for use in a rubber formulation, comprising the steps of:
selecting a target loading value L desired for the rubber formulation;
deciding upon n target intrinsic properties that are desired for the blend, where n is an integer greater than one;
choosing a target intrinsic property value Xᵢ for each of the n target intrinsic properties;
picking n fillers suitable for use in creating the blend;
providing, for each of the n target intrinsic properties, a mathematical relationship fᵢ between the target loading value L, the target intrinsic property value Xᵢ, the corresponding intrinsic property value xᵢⱼ, and the loading Lⱼ of each of the n fillers from said picking step; and
calculating the loading Lⱼ for each of the n fillers from said picking step.

6. A method for creating a blend of fillers for use in a rubber formulation as in claim 1, wherein one of the n target intrinsic properties Xᵢ desired for the blend is the structure of filler in the blend.

7. A method for creating a blend of fillers for use in a rubber formulation as in claim 1, wherein one of the n target intrinsic properties Xᵢ desired for the blend is the surface area of filler in the blend.

8. A method for creating a blend of fillers for use in a rubber formulation as in claim 1, wherein two of the n target intrinsic properties Xᵢ desired for the blend is the surface area and structure of filler in the blend.

9. A method for creating a blend of fillers for use in a rubber formulation as in claim 1, wherein the mathematical relationship fᵢ for each of the n target intrinsic properties is a first order equation that includes the individual loadings Lⱼ and intrinsic property values xᵢ for each of the n fillers from said picking step.

10. A method for creating a blend of fillers for use in a rubber formulation as in claim 5, wherein the mathematical relationships fᵢ for the n target intrinsic properties are linearly independent from one another.

11. A method for creating a blend of fillers for use in a rubber formulation as in claim 1, wherein the mathematical relationship fᵢ for each of the n target intrinsic properties is a polynomial equation that includes the individual loadings Lⱼ and intrinsic property values ᵢⱼ for each of the n fillers from said picking step.

12. A method for creating a blend of fillers for use in a rubber formulation as in claim 1, further comprising the step of blending the n fillers from said picking step according to the loadings Lⱼ provided by said calculating step to create the filler.

13. A method for creating a blend of fillers for use in a rubber formulation as in claim 12, further comprising the step of manufacturing a tire using the filler from the said blending step.

14. A method for creating a blend of fillers for use in a rubber formulation, comprising the steps of:
selecting a target loading value L for the rubber formulation;
deciding upon n target intrinsic properties that are desired for the blend, where n is an integer greater than one;
choosing a target intrinsic property value Xᵢ for each of the n target intrinsic properties;
picking a loading value Lⱼ for each of n fillers that will be used in creating the blend;
choosing n−1 fillers with known intrinsic properties so as to leave one unidentified filler;
providing, for each of the n target intrinsic properties, a mathematical relationship fᵢ between the target loading value L, the target intrinsic property value Xᵢ, the corresponding intrinsic property value xᵢⱼ, and the loading Lⱼ of each of the n fillers from said picking step;
calculating the corresponding intrinsic property values xᵢⱼ for the unidentified filler from said choosing step; and
determining the identity of the unidentified filler from said choosing step by matching the intrinsic property values xᵢⱼ from said calculating step with a filler having substantially the same intrinsic property values xᵢⱼ as provided by said calculating step.

15. A method for creating a blend of fillers for use in a rubber formulation as in claim 14, wherein one of the n target intrinsic properties Xᵢ desired for the blend is the structure of filler in the blend.

16. A method for creating a blend of fillers for use in a rubber formulation as in claim 14, wherein one of the n target intrinsic properties Xᵢ desired for the blend is the surface area of filler in the blend.

17. A method for creating a blend of fillers for use in a rubber formulation as in claim 14, wherein two of the n target intrinsic properties Xᵢ desired for the blend is the surface area and structure of filler in the blend.

18. A method for creating a blend of fillers for use in a rubber formulation as in claim 14, wherein the mathematical relationship fᵢ for each of the n target intrinsic properties is a first order equation that includes the individual loadings Lⱼ and intrinsic property values xᵢ for each of the n fillers from said picking step.

19. (canceled)

20. A method for creating a blend of fillers for use as filler in a rubber formulation as in claim 14, wherein the mathematical relationship fᵢ for each of the n target intrinsic properties is a polynomial equation that includes the individual loadings Lⱼ and intrinsic property values xᵢⱼ for each of the n fillers from said picking step.

21. A method for creating a blend of fillers for use in a rubber formulation as in claim 14, further comprising the step of blending the n fillers identified in said determining step according to the loadings Lⱼ provided by said picking step so to create the filler.

22. (canceled)

23. (canceled)
